(19) United States
(12) Patent Application Publication
(10) Pub. No.: US 2024/0395020 A1
(43) Pub. Date: Nov. 28, 2024

(54) SYSTEM AND METHOD FOR PRINTING AND SCREENING IMAGES OR PHOTO FOR INMATES IN PENAL INSTITUTIONS

(71) Applicant: Inmate Photos, LLC, Henderson, NV (US)

(72) Inventor: Curtis Gebers, Henderson, NV (US)

(21) Appl. No.: 18/673,141

(22) Filed: May 23, 2024

Related U.S. Application Data
(60) Provisional application No. 63/468,485, filed on May 23, 2023.

(51) Int. Cl. G06V 10/764; G06F 3/12

(52) U.S. Cl. CPC G06V 10/765; G06F 3/1222; G06F 3/1238

(57) ABSTRACT

A system and method for printing and screening images or photos for inmates includes an application server with a processor programmed with an algorithm to execute steps to receive a log-in from a user, receive a selection of a facility where an inmate is located, receive a name and identification (ID) number of the inmate, receive an agreement by the user to a list of predefined rules for the facility, receive an upload of at least one image or photo, receive a check-out and payment for the at least one image or photo, print the at least one image as a photo with the name and the ID number, screen the printed at least one image or photo according to the predefined rules, send the screened at least one image or photo to the facility, and deliver the screened at least one image or photo to the inmate.

### CROSS-REFERENCE TO RELATED APPLICATION(S)

The present application claims priority to and the benefit of U.S. Provisional Patent Application Ser. No. 63/468,485, filed May 23, 2023, the disclosure of which is hereby incorporated by reference in its entirety.

### BACKGROUND OF THE INVENTION

### 1. Field of the Invention

The present invention relates generally to the field of penal institutions or similar facilities and, more particularly, to a system and method for printing and screening images or photos for inmates in penal institutions or similar facilities.

### 2. Description of the Related Art

Images or photos may be sent to an inmate at a penal institution or facility. The facility screens the images or photos to make sure that they comply with the rules of the facility. If they do comply, the images or photos are delivered to the inmate.

It is desirable to provide a system and method that allows the printing of images or photos sent to inmates. It is also desirable to provide a system and method that screens printed images or photos according to predefined rules prior to being sent to the facility for delivery to the inmate. Therefore, there is a need in the art to provide such a system and method that meets at least one of these desires.

### SUMMARY OF THE INVENTION

The present invention provides a system for printing and screening of images or photos for inmates in penal institutions or similar facilities. The system includes an application server having a processor programmed with an algorithm to execute steps to receive a log-in from a user, receive a selection of a facility where an inmate is located, receive a name and identification number (ID) of the inmate, receive an agreement to a list of predefined rules for the facility, receive an upload of at least one image or photo, receive a check-out and payment for the at least one image or photo, print the at least one image or photo with the name and the ID number of the inmate, screen the printed at least one image or photo according to the predefined rules, send the printed at least one screened image or photo to the facility, and deliver the at least one screened image or photo to the inmate.

In another embodiment, the present invention provides a method for printing and screening images or photos for inmates in penal institutions or similar facilities. The method includes the steps of receiving, by an application server, a log-in from a user, receiving, by an application server, a selection of a facility where an inmate is located, receiving, by an application server, a name and identification number (ID) of the inmate, receiving, by an application server, an agreement to a list of predefined rules for the facility, receiving, by an application server, an upload of at least one image or photo, receiving, by an application server, a check-out and payment for the at least one image or photo, printing, by an application server, the at least one image or photo with the name and the ID number of the inmate, screening, by an application server, the at least one photo printed according to the predefined rules, sending the at least one screened image or photo to the facility, and delivering the at least one image or photo screened to the inmate.

In yet another embodiment, the present invention provides one or more non-transitory computer-readable storage media, having computer executable instructions embodied thereon, where when executed by at least one processor, the computer-executable instructions cause the processor to receive a log-in from a user, receive a selection of a facility where an inmate is located, receive a name and identification number (ID) of the inmate, receive an agreement to a list of predefined rules for the facility, receive an upload of at least one image or photo, receive a check-out and payment for the at least one image or photo, print the at least one image or photo with the name and the ID number of the inmate, screen the printed at least one image or photo according to the predefined rules, send the printed at least one screened image or photo to the facility, and deliver the at least one screened image or photo to the inmate.

One advantage of the present invention is that a system and method is provided for printing of images or photos that are sent to inmates in a penal institution or similar facility. Another advantage of the present invention is that the system and method screens images or photos according to predefined rules before sending the printed images or photos to the penal institution or facility for delivery to inmates.

Other advantages of the present invention will be readily appreciated, as the same becomes better understood, by reference to the following detailed description when considered in connection with the accompanying drawings.

### BRIEF DESCRIPTION OF THE DRAWINGS

FIG. 1 is a schematic view illustrating various aspects of a system, according to the present invention.

FIG. 2 is a plan view of a component of the system of FIG. 1.

FIG. 3 is a schematic view illustrating example components of a server computer that may be used with the system shown in FIG. 1.

FIG. 4 is a flowchart of a method, according to one embodiment of the present invention, that may be used with the system shown in FIG. 1.

Corresponding reference characters indicate corresponding components throughout the several views of the drawings.

### DESCRIPTION OF THE PREFERRED EMBODIMENT(S)

In the following description, numerous specific details are set forth to provide a thorough understanding of the present invention. It will be apparent, however, to one having ordinary skill in the art that the specific detail need not be employed to practice the present invention. In other instances, well-known materials or methods have not been described in detail to avoid obscuring the present invention.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random-access memory (RAM) device, a read-only memory (ROM) device, a reasonable programmable read-only memory (CDROM), an optical storage device, and a magnetic storage device. Computer program code for carrying out operations of the present invention may be written in any combination of one or more programming languages.

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which includes one or more executable instructions for implementing the specified logical function(s). It will be appreciated that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instructions which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

In general, the present invention provides a system 10 such as a networked computer system that includes application software that enables the system 10 to receive, print, and screen images or photos for inmates in penal institutions or similar facilities. It should be appreciated that the term “inmate” refers to a “person in a prison or jail” or “incarcerated individual”. It also should be appreciated that the term “civilian” refers to a “non-inmate” and “civilians” refers to “non-inmates” as used in the subsequent description.

The application software provides the system 10 with a platform to allow civilians to upload and print image(s) or photo(s) to be delivered to inmate(s) at facilities. The application software includes a program version that has a user version available in all the application stores and potentially pre-installed as a part of default carrier software loads (for example: AT&T, Sprint, Verizon, etc.) that will provide the functionality to be described below. Several elements discussed below and/or claimed are described as being provided for, or, by “a user”, “an inmate”, or “a civilian” and may be interchangeable throughout and described below.

Moreover, the system 10 communicates with a mobile device associated with the civilian and may send uploaded image(s) or photo(s) to a 3^{rd} party computer server to print image(s) or photo(s) to be sent to inmates at facilities where they are located. The application server may communicate with the 3^{rd} party computer server to send the image or photo to be printed for mailing to the facility and delivery to the inmate. The system 10 may also include a mobile computer application being stored on a mobile device associated with the user. The system 10 may send the image to the 3^{rd} party server to be printed and mailed to the facility and/or inmate through the postal service.

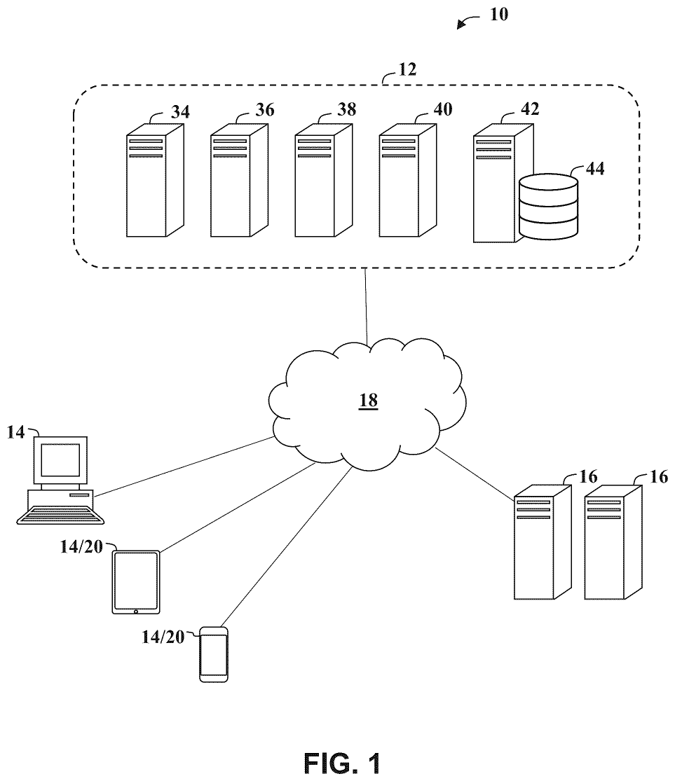

Referring to FIG. 1, in one illustrated embodiment, the system 10 includes a server system 12 that is coupled in communication with one or more user computing devices 14 and one or more 3^{rd} party computer servers 16 via a communications network 18. The server system 12 may be any suitable server, including an internet transaction server (ITS), an ATG application server or an ATG application instance, a Dynamo server, etc. . . . , and may utilize any suitable or combination of technologies configured to enable efficient communication. The communications network 18 may be any suitable connection, including the Internet, Voice Over IP (VOIP), file transfer protocol (FTP), an Intranet, LAN, a virtual private network (VPN), cellular networks, etc. . . . , and may utilize any suitable or combination of technologies including, but not limited to wired and wireless connections, always on connections, connections made periodically, and connections made as needed. It should be appreciated that such a system is disclosed in U.S. Pat. No. 10,616,234, issued Apr. 7, 2020, the entire disclosure of which is hereby incorporated by reference.

The user computing device 14 may include any suitable device that enables the user to log-in and communicate with the system 10 including sending and/or receiving information to and from the system 10 and displaying information received from the system 10 to the user. For example, in one embodiment, the user computing device 14 may include, but is not limited to, a desktop computer, a laptop or notebook computer, a tablet computer, a smartphone/tablet computer hybrid, a personal data assistant, a handheld mobile device including a cellular telephone, and the like.

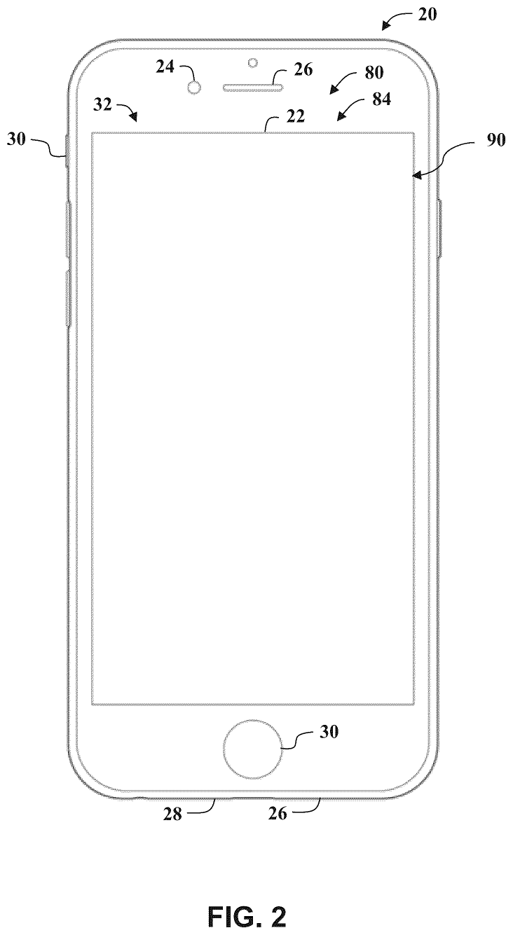

In one embodiment, the user computing device 14 includes a mobile computing device 20 (shown in FIG. 2) such as, for example, a smartphone such as an iPhone™. Both the user computing device 14 and the mobile computing device 20 include a processor coupled to a memory device for storing various programs and data for use in operating the mobile computing device 20.

The mobile computing device 20 may also include a touchscreen display device 22, one or more video image cameras 24, one or more speakers 26, a microphone 28, at least one input button 30, and one or more sensors including, but not limited to, a touch ID fingerprint sensor coupled to an input button 30, a barometer, a three-axis gyro, an accelerometer, a proximity sensor, and an ambient light sensor. In addition, the mobile computing device 20 may also include a Wi-Fi antenna, a cellular network antenna, a Bluethooth™ communications device, assisted GPS and GLONASS, a digital compass, and an iBeacon microlocation device.

In the illustrated embodiment of FIG. 2, the mobile computing device 20 includes a web browser programmed and stored in the memory device. The processor executes the web browser program to display web pages on the touchscreen display device 22 that includes information received from the server system 12 to enable the user to interact with and operate the server system 12. In addition, the mobile computing device 20 may be programmed to store and execute a mobile program application, e.g., a mobile application, which displays a user interface 32 on the touch screen display device 22 that allows the user to access the server system 12 to retrieve and store information within the server system 12 as well as interact with and operate the server system 12. In addition, in one embodiment, the system 10 may install one or more mobile application programs in the memory device of the mobile computing device 20. When initiated by the processor of the mobile computing device 20, the mobile application program causes the processor of the mobile computing device 20 to perform some or all the functions of the server system 12.

The 3^{rd} party computer server 16 includes information and data associated with the processing of images or photos. For example, in one embodiment, the 3^{rd} party computer server 16 may include information associated with an image or photo printing system that receives a request to print images or photos to be sent to the inmates. In one embodiment, the image or photo printing system adds the inmate's name and their ID numbers to the front and/or back of the images or photos. In one embodiment, the printed images or photos are physically mailed or delivered to the inmates. In another embodiment, the printed images or photos are physically mailed to the facility and physically delivered to the inmates. It should be appreciated that adding the inmate's name and their ID numbers to the front and/or back of the printed images or photos helps staff of the penal institution or other facility to know which inmate the printed image or photo belongs to and stops trading and/or stealing of printed images or photos between inmates.

In addition, the 3^{rd} party computer servers 16 may provide screening of the printed images or photos. In this embodiment, the printed images or photos are prescreened against rules of the penal institution or other facility to determine if the printed images or photos are acceptable before delivering the printed images or photos to the inmate. In one embodiment, a human is used to screen the printed images or photos being sent to the penal institution or other facility for rule violations of the penal institution or other facility. In another embodiment, artificial intelligence (AI) software such as an AI bot is used to screen the printed images or photos being sent to the penal institution or other facility for rule violations of the penal institution or other facility.

In the illustrated embodiment of FIG. 1, the server system 12 may include one or more servers such as a website hosting server 34, a search engine server 36, an application server 38, an external server 40, a database server 42, and a database 44. The database server 42 includes a memory device that is connected to the database 44 to retrieve and store information contained in the database 44.

The website hosting server 34 is configured to host a website that is accessible by the user (also known as civilian) via one or more user computing devices 14. The website hosting server 34 retrieves and stores web pages associated with one or more websites in response to requests received by the civilian via the user computing device 14 to allow consumers to interact with the website. In one embodiment, the website hosting server 34 may be configured to generate and display a mobile web page, the mobile web page can be the civilian web page that is displayed on one or more mobile computing devices 20.

In the illustrated embodiment, the search engine server 36 is configured to receive a search request from the website hosting server 34 and/or the application server 38 including one or more search terms, and generate search data as a function of the search terms.

In the illustrated embodiment, the application server 38 is programmed to monitor activities and process the images or photos being sent and received.

The application server 38 is configured to receive information from the website hosting server 34 and the search engine server 36, and send the information to the database server 42 to be stored in the database 44. In another embodiment, the database server 42 receives all the information collected by the application server 38 and stores the information in the database 44.

The external server 40 is configured to interact with the 3^{rd} party server 16 that is outside of the application server 38. In addition, the external server 40 is configured to connect with the 3^{rd} party server 16 using secret authentication mechanisms, application keys, call different methods on the external server 40, APIs, and reformat the results of the data back for use by the application server 38 so that the application server 38 can send the data to the website hosting server 34 to be displayed on the user computing device 14. The external server 40 is configured to be a bridge between the products and/or services completely separate from the application server 38. The products and/or services that are outside of the application server 38 include all external services, for example, any image or photo printing service that prints the images or photos. These products and/or services may provide information to the application server 38 that the sent images printed or photos printed are ready for pick-up to be mailed to the inmates.

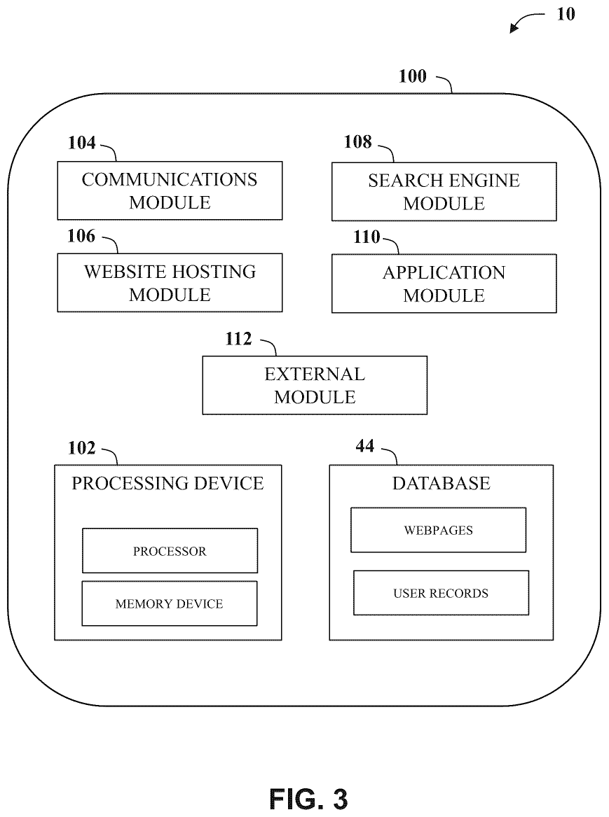

Referring to FIG. 3, in one embodiment, the system 10 may include a system server 100 that is configured to perform the functions of the website hosting server 34, the search engine server 36, the application server 38, the external server 40, and the database server 42. In the illustrated embodiment, the system server 100 includes a processing device 102 and the database 44.

The processing device 102 executes various programs, and thereby controls components of the system server 100 according to user instructions received from the user computing device 14. The processing device 102 may include memory, e.g., read only memory (ROM) and random-access memory (RAM), storing processor-executable instructions and one or more processors that execute the processor-executable instructions. In embodiments where the processing device 102 includes two or more processors, the processors can operate in a parallel or distributed manner. In one example, the processing device 102 may execute a communications module 104, a website hosting module 106, a search engine module 108, an application module 110, and an external module 112.

The processing device 102 may also include a memory device for storing programs and information in the database 44, and retrieving information from the database 44 that is used by the processor to perform various functions described herein. The memory device may include, but is not limited to, a hard disc drive, an optical disc drive, and/or a flash memory drive. Further, the memory device may be distributed and located at multiple locations.

The communications module 104 retrieves various data and information from the database 44 and sends information to the user computing device 14 via the communications network 18 to enable the user to access and interact with the system 10. In one embodiment, the communications module 104 displays various images on a graphical interface of the user computing device 14 preferably by using computer graphics and image data stored in the database 44 including, but not limited to, user records, messages, and/or any suitable information and/or images that enable the system 10 to function as described herein.

The website hosting module 106 may be programmed to perform some or all the functions of the website hosting server 34 including hosting various web pages associated with one or more websites that are stored in the database 44 and that are accessible to the user via the user computing device 14. The website hosting module 106 may be programmed to generate and display webpages associated with a website in response to requests being received from users via corresponding web browsers.

The search engine module 108 may be programmed to perform some or all the functions of the search engine server 36 including generating and storing search data in response to the user search request and/or application module 110 search requests.

The application module 110 may be programmed to perform some or all the functions of the application server 38.

The external module 112 may be programmed to perform some or all the functions of the external server 40 including generating, receiving, and storing the external data including data from the 3rd party server computer 16.

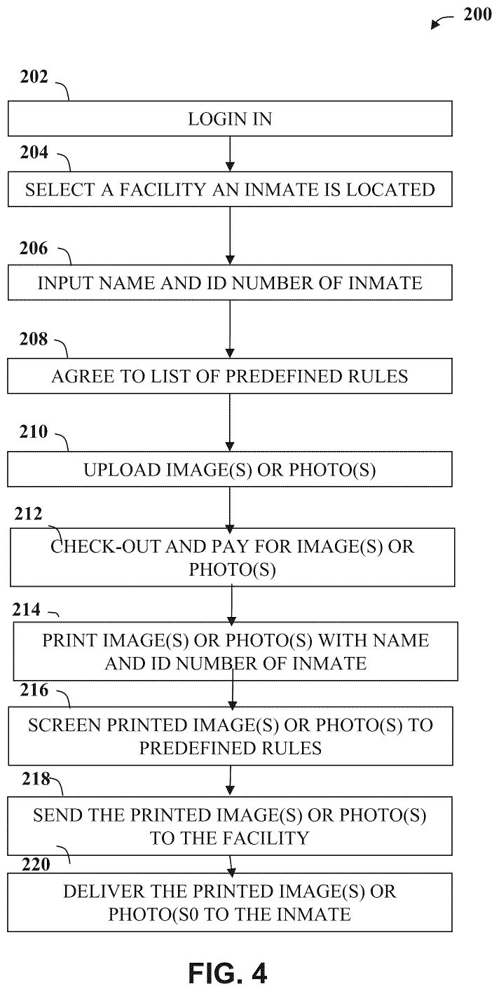

Referring to FIG. 4, a flowchart of one embodiment of a method 200, according to the present invention, which may be used with the system 10 for printing and screening images or photos for inmates in penal institutions or similar facilities. The method 200 includes a plurality of steps, for example, steps 202-220. The processor of the application server 38 is programmed with an algorithm to execute the steps of the method 200. It should be appreciated that each method step may be performed independently of, or in combination with, other method steps. It should also be appreciated that portions of the method may be performed by any one of, or any combination of, the components of the system 10.

In method step 202, the application server 38 is configured to determine whether the user has logged-in. For example, the user may use the application 108 to log-in. In method step 204, the application server 38 is configured to receive a selection of a facility where an inmate is located. For example, the user may use the application 108 to select a facility where an inmate is located.

Further, in method step 206, the application server 38 is configured to receive an input of the name and identification (ID) number of the inmate. For example, the user may use the application 108 to input the name and ID number of the inmate.

In method step 208, the application server 38 is configured to receive an input of the user agreement to a list of predefined rules for the facility where the inmate is located. For example, the application server 38 may present a list of predefined rules of the facility where the inmate is located such as no adult content or gang symbols and the user may use the application 108 to agree to the list of predefined rules.

In method step 210, the application server 38 receives uploads of the image(s) or photo(s) from the user. For example, the user may use the application 108 to upload image(s) or photo(s) to be sent to the inmate. It should be appreciated that the user may use the application 108 to retrieve image(s) or photo(s) from a Facebook™ or Instagram™ account.

In method step 212, the application server 38 receives an input for check-out and payment from the user. For example, the user may use the application 108 to check-out and pay for image(s) or photo(s) to be printed and sent to the inmate.

In method step 214, the application server 38 sends the uploaded image(s) or photo(s) to the 3^{rd} party computer server 16 to print the uploaded image(s) or photo(s). The 3^{rd} party computer server 16 receives information and data associated with the processing of the uploaded image(s) or photo(s). For example, in one embodiment, the 3^{rd} party computer server 16 may include information associated with an image or photo printing system that receives a request to print images or photos to be mailed to the inmates. In one embodiment, the image or photo printing system adds the inmate's name and their ID number to the front and/or back of the images or photos printed. It should be appreciated that adding the inmate's name and their ID number to the front and/or of the images or photos printed helps staff of the penal institution or other facility to know which inmate the printed images or photos belong to and stops trading and/or stealing of printed images or photos between inmates.

In method step 216, the 3^{rd} party computer server 16 may provide screening of the printed images or photos. In this embodiment, the printed images or photos are prescreened against rules of the penal institution or other facility to determine if the printed images or photos are acceptable before sending a printed image or photo to the inmate. In one embodiment, a human is used to screen the printed images or photos being sent to the penal institution or other facility for rule violations of the penal institution or other facility. In another embodiment, artificial intelligence (AI) software such as an AI bot is used to screen the printed images or photos being sent to the penal institution or other facility for rule violations of the penal institution or other facility.

In method step 218, the application server 38 sends the printed image(s) or photo(s) to the facility. In method step 220, the facility may screen the printed image(s) or photo(s) before delivering the printed image(s) or photo(s) to the inmate.

A controller, computing device, server or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term “processor”.

In some embodiments, the database 44, as described herein, includes any collection of data including hierarchical databases, relational databases, flat file databases, object-relational databases, object-oriented databases, and any other structured collection of records or data that is stored in a computer system. The above examples are exemplary only, and thus are not intended to limit in any way the definition and/or meaning of the term database. Examples of databases include, but are not limited to only including Oracle® Database, MySQL, IBM® DBXX, Microsoft® SQL Server, Sybase®, and PostgreSQL. However, any database 44 may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

The present invention has been described in an illustrative manner. The above description of illustrated examples of the present invention, including what is described in the Abstract, are not intended to be exhaustive or to be limitation to the precise forms disclosed. While specific embodiments of, and examples for, the present invention are described herein for illustrative purposes, various equivalent modifications are possible without departing from the broader spirit and scope of the present invention.

1. A system for printing and screening images or photos for inmates in penal institutions or similar facilities, the system comprising:
an application server including a processor programmed with an algorithm to execute steps to:
receive a log-in from a user;
receive a selection of a facility where an inmate is located;
receive a name and identification (ID) number of the inmate;
receive an agreement by the user to a list of predefined rules for the facility;
receive an upload of at least one image or photo;
receive a check-out and payment for the at least one image or photo;
print the at least one image as a photo with the name and the ID number of the inmate;
screen the printed at least one image or photo according to the predefined rules;
send the screened at least one image or photo to the facility; and
deliver the at least one screened image or photo to the inmate.

2. The system as set forth in claim 1, wherein the application server is further programmed to receive a request to print the at least one image or photo.

3. The system as set forth in claim 2, wherein the application server is further programmed to add the name and ID number to the front and/or back of the at least one image or photo.

4. The system as set forth in claim 2, wherein the at least one printed image or photo is physically mailed to the facility.

5. The system as set forth in claim 2, wherein the at least one printed image or photo is physically delivered to the inmate.

6. The system as set forth in claim 1, wherein the application server is further programmed to prescreen the at least one printed image or photo against the predefined rules to determine if the at least one printed image or photo is acceptable to be delivered to the inmate.

7. The system as set forth in claim 6, wherein the application server is further programmed to include artificial intelligence software to screen the at least one printed image or photo against the predefined rules for rule violations.

8. A method for printing and screening images or photos for inmates in penal institutions or similar facilities, said method comprising the steps of:
receiving, by an application server, a log-in from a user;
receiving, by an application server, a selection of a facility where an inmate is located;
receiving, by an application server, a name and identification (ID) number of the inmate;
receiving, by an application server, an agreement by the user to a list of predefined rules for the facility;
receiving, by an application server, an upload of at least one image or photo;
receiving, by an application server, a check-out and payment for the at least one image or photo;
printing, by an application server, the at least one image or photo with a name and ID number of the inmate;
screening, by an application server, the at least one photo printed according to predefined rules;
sending the at least one screened image or photo to the facility; and
delivering the at least one image or photo screened to the inmate.

9. The method as set forth in claim 8, wherein the method further comprises the step of receiving, by an application server, a request to print the at least one image or photo.

10. The method as set forth in claim 8, wherein the method further comprises the step of adding, by an application server, the name and ID number to the front and/or back of the at least one image or photo printed.

11. The method as set forth in claim 8, wherein the at least one image or photo printed is physically mailed to the facility.

12. The method as set forth in claim 8, wherein the at least one image or photo printed is physically delivered to the inmate.

13. The method as set forth in claim 8, wherein the method further comprises the step of prescreening, by an application server, the at least one image or photo printed against the predefined rules to determine if the at least one image or photo printed is acceptable.

14. The method as set forth in claim 13, wherein the step of prescreening comprises prescreening the at least one printed image or photo with artificial intelligence software against the predefined rules prior to the at least one image or photo being sent to the facility for rule violations.

15. One or more non-transitory computer-readable storage media, having computer executable instructions embodied thereon, where when executed by at least one processor, the computer-executable instructions cause the processor to:
receive a log-in from a user;
receive a selection of a facility where an inmate is located;
receive a name and identification (ID) number of the inmate;
receive an agreement by the user to a list of predefined rules for the facility;
receive an upload of at least one image or photo;
receive a check-out and payment for the at least one image or photo;
print the at least one image as a photo with the name and the ID number of the inmate;
screen the printed at least one image or photo according to the predefined rules;
send the screened at least one image or photo to the facility; and
deliver the screened at least one image or photo to the inmate.

16. The one or more non-transitory computer-readable storage media as set forth in claim 15 wherein the computer-executable instructions cause the processor to receive a request to print the at least one image or photo.

17. The one or more non-transitory computer-readable storage media as set forth in claim 16 wherein the computer-executable instructions cause the processor to add the name and ID number to the front and/or back of the at least one image or photo.

18. The one or more non-transitory computer-readable storage media as set forth in claim 17 wherein the computer-executable instructions cause the processor causes the at least one printed image or photo is physically mailed to the facility.

19. The one or more non-transitory computer-readable storage media as set forth in claim 16 wherein the computer-executable instructions cause the processor to prescreen the at least one printed image or photo against the predefined rules to determine if the at least one printed image or photo is acceptable to be delivered to the inmate.

20. The one or more non-transitory computer-readable storage media as set forth in claim 16 wherein the computer-executable instructions cause the processor to include artificial intelligence software to screen the at least one printed image or photo against the predefined rules for rule violations.
